(19) United States
(12) Patent Application Publication
(10) Pub. No.: US 2008/0060997 A1
(43) Pub. Date: Mar. 13, 2008

(54) METHOD OF HEAVY METALS REMOVAL FROM MUNICIPAL WASTEWATER

(76) Inventors: Deepak A. Musale, Aurora, IL (US); Jeroen A. Koppes, Leiden (NL)

Correspondence Address: Peter A. DiMattia;Patent and Licensing Department, Nalco Company, 1601 West Diehl Road, Naperville, IL, 60563-1198, US

(21) Appl. No.: 11/695,819

(22) Filed: Apr. 3, 2007

Related U.S. Application Data
(63) Continuation-in-part of application No. 11/516,843, filed on Sep. 7, 2006.

(51) Int. Cl. C02F 1/26

(52) U.S. Cl. 210/633

(57) ABSTRACT

A method of removing one or more heavy metals from municipal wastewater by use of a membrane separation process is disclosed. Specifically, the following steps are taken to remove heavy metals from municipal wastewater: (a) collecting a municipal wastewater containing heavy metals in a receptacle suitable to hold said municipal wastewater; (b) adjusting the pH of said system to achieve hydroxide precipitation of said heavy metal in said municipal wastewater; (c) adding an effective amount of a water soluble ethylene dichloride-ammonia polymer having a molecular weight of from about 500 to about 10,000 daltons that contain from about 5 to about 50 mole percent of dithiocarbamate salt groups to react with said heavy metals in said municipal wastewater system; (d) optionally clarifying the treated wastewater from step c; (e) passing said treated municipal wastewater through a submerged membrane, wherein said submerged membrane is an ultrafiltration membrane or a microfiltration membrane; and (f) optionally back-flushing said membrane to remove solids from the membrane surface.

### CROSS REFERENCE TO RELATED APPLICATION

This application is a continuation-in-part of U.S. Ser. No. 11/516,843, filed on Sep. 7, 2006. The subject matter contained in U.S. Ser. No. 11/516,843 is herein incorporated by reference.

### FIELD OF THE INVENTION

This invention pertains to a method of heavy metals removal from municipal wastewater via the use of a submerged ultrafiltration or microfiltration membrane system.

### BACKGROUND

Due to stringent environmental regulations and/or water shortages, several municipalities have to remove heavy metals from wastewaters before discharge or reuse. The European Water Framework Directive (2000/60/EC) indicates future discharge reduction of priority substances such as heavy metals. This regulation is based on the Maximum Allowable Risk principal meaning that a compound discharged to the environment should cause no or a negligible environmental or human risk. The Dutch interpretation of this European legislation is described in the national legislation entitled: “4e Nota Waterhuishuiding”. This legislation describes, among others, the future surface water discharge limits for metals. An example from this legislation are the following possible soluble metal discharge requirements: Cadmium: 0.4 ppb, Copper: 1.5 ppb, Nickel: 5.1 ppb, Lead: 11 ppb, Zinc: 9.4 ppb, Chromium: 8.7 ppb and Arsenic: 25 ppb. Currently, most of the heavy metal containing wastewaters are treated by commodity DTC/TTC chemistries or specialty polymeric DTC compounds and then the precipitated metals are separated in a clarifier. In recent years, ultrafiltration (UF) or microfiltration (MF) membranes are increasingly being used for solid-liquid separation instead of clarifiers, because UF/MF membrane processes are much more compact and result in water with much better quality than clarifiers; specifically there are almost no suspended solids and negligible turbidity. The UF or MF permeate can be reused with or without any further treatment, depending on purpose: of reuse. Therefore, municipal wastewaters when treated with polymeric chelants and subsequently filtered through UF or ME membranes result in high metal removal and also in higher membrane fluxes than those treated with commodity DTC/TTC/TMT chemistries.

Although cross-flow UF or MF processes have been used for this application, the operating cost of these processes is usually high due to high cross-flow energy required to minimize membrane fouling. In last decade or so, submerged UF and MF membranes have been successfully used for the high-suspended solids separation application such as in Membrane Bioreactors (MBR) or low suspended solid applications such as raw water treatment and tertiary treatment. Submerged membranes operate at low fluxes (10-60 LMH) in these applications, as membranes get fouled at higher fluxes. For minimizing membrane fouling, aeration is used to scour the membrane surface, either continuously (e.g. in MBR) or intermittently (e.g. in MBR, raw water and tertiary treatment). Therefore, it is of interest to adapt these relatively low operating cost submerged membrane systems for other applications such as heavy metal removal in conjunction with polymeric chelants, which function as metal complexing agents as well as membrane flux enhancers. The application of polymer chelants in filtration systems is discussed in U.S. Pat. Nos. 5,346,627 and 6,258,277, which are herein incorporated by reference.

### SUMMARY OF THE INVENTION

The present invention provides a method of removing one or more heavy metals from municipal wastewater by use of a membrane separation process comprising the following steps: (a) collecting a municipal wastewater containing heavy metals in a receptacle suitable to hold said municipal wastewater; (b) adjusting the pH of said system to achieve hydroxide precipitation of said heavy metal in said municipal wastewater; (c) adding an effective amount of a water soluble ethylene dichloride ammonia polymer having a molecular weight of from about 500 to about 10,000 daltons that contain from about 5 to about 50 mole percent of dithiocarbamate salt groups to react with said heavy metals in said municipal wastewater system; (d) optionally clarifying the treated wastewater from step c; (e) passing said treated municipal wastewater through a submerged membrane, wherein said submerged membrane is an ultrafiltration membrane or a microfiltration membrane; and (f) optionally back-flushing said membrane to remove solids from the membrane surface.

### BRIEF DESCRIPTION OF THE DRAWING

FIG. 1 illustrates a general process scheme for processing municipal wastewater containing heavy metals, which includes a submerged microfiltration membrane/ultrafiltration membrane as well as an additional membrane for further processing of the permeate from said submerged microfiltration membrane/ultrafiltration membrane.

FIG. 2 illustrates a general process scheme for wastewater that was treated with 10-20 ppm of ethylene dichloride ammonia (EDC-NH₃) polymer, settled in a clarifier and the clarified water was then filtered through a submerged hollow fiber UF membrane.

### DETAILED DESCRIPTION OF THE INVENTION

### Definitions of Terms:

“UF” means ultrafiltration.

“MF” means microfiltration.

“DTC” means dimethyl dithiocarbamate.

“TTC” means trithiocarbonate.

“TMT” means trimercaptotriazine.

“TMP” means trans membrane pressure.

“LMH” means liters per meters² per hour.

“Flux” means amount of water filtering through the membrane per unit time per unit membrane area.

“Municipal wastewater” means wastewater from municipal wastewater treatment plants that are centralized or decentralized. Centralized water treatment plants include wastewater from households and industry. Decentralized water treatment plants include wastewater from apartment complexes, hotels, resorts and the like, that treat their own wastewater.

“Chelant scavengers” means compounds that are capable of complexing with chelants. These scavengers are usually, but are not limited to, the salt form.

“Submerged Membrane” means a membrane that is completely submerged under the body of liquid to be filtered.

“Polymeric Chelant” means a polymeric molecule that reacts and/or complexes with heavy metals.

“Amphoteric polymer” means a polymer derived from both cationic monomers and anionic monomers, and, possibly, other non-ionic monomer(s). Amphoteric polymers can have a net positive or negative charge. The amphoteric polymer may also be derived from zwitterionic monomers and cationic or anionic monomers and possibly nonionic monomers. The amphoteric polymer is water soluble.

“Cationic polymer” means a polymer having an overall positive charge. The cationic polymers of this invention are prepared by polymerizing one or more cationic monomers, by copolymerizing one or more nonionic monomers and one or more cationic monomers, by condensing epichlorohydrin and a diamine or polyamine or condensing ethylenedichloride and ammonia or formaldehyde and an amine salt. The cationic polymer is water soluble.

“Zwitterionic polymer” means a polymer composed from zwitterionic monomers and, possibly, other non-ionic monomer(s). In zwitterionic polymers, all the polymer chains and segments within those chains are rigorously electrically neutral. Therefore, zwitterionic polymers represent a subset of amphoteric polymers, necessarily maintaining charge neutrality across all polymer chains and segments because both anionic charge and cationic charge are introduced within the same zwitterionic monomer. The zwitterionic polymer is water-soluble.

“Anionic polymer” means a polymer having an overall negative charge. The anionic polymers of this invention are prepared by polymerizing one or more anionic monomers or by copolymerizing one or more non-ionic monomers and one or more anionic monomers. The anionic polymer is water-soluble.

### PREFERRED EMBODIMENTS

As stated above, the invention provides for a method of removing one or more heavy metals from municipal wastewater by use of either a submerged microfiltration membrane or a submerged ultrafiltration membrane.

If chelants are present in the municipal wastewater, then pH needs to be adjusted to de-complex the metal from the chelant in the municipal wastewater, and there needs to be a subsequent or simultaneous addition of one or more chelant scavengers. Chelant will usually de-complex from a metal when the pH is less than four, preferably the pH is adjusted in the range of from about 3 to about 4.

In one embodiment, the chelant scavengers contain Ca or Mg or Al or Fe.

In another embodiment, the chelant scavenger containing Fe is selected from the group consisting of: ferrous chloride; ferrous sulfate; ferric chloride; ferric sulfate; or a combination thereof.

Various types and amounts of acids and bases maybe utilized to adjust the pH of municipal wastewater.

In one embodiment, the base may be selected from the group consisting of magnesium and calcium salts such as chlorides and hydroxides.

In another embodiment, the base is selected from the group consisting of hydroxides of sodium, potassium, ammonium and the like.

Various iron compounds and dosages may be utilized to further treat the pH adjusted municipal wastewater. In yet another embodiment the dosages of iron compounds used may be from about 1 ppm to about 10,000 ppm, depending upon the level of chelant present in the municipal wastewater.

One step of removing heavy metals from an municipal wastewater system is the step of adjusting the pH of the system to achieve hydroxide precipitation of said heavy metal in said municipal wastewater. Hydroxide precipitation occurs when the wastewater pH is such that the metal hydroxide has a minimum solubility.

In a preferred embodiment, the pH of the municipal wastewater is raised to a pH of about 7 to about 10. The pH level adjustment of the municipal wastewater depends on the metal present. Any base that allows for pH adjustment to the desired range is envisioned. For example, the base selected for pH adjustment is selected from the group consisting of hydroxides of: sodium, potassium, magnesium, calcium, ammonium and the like.

In another embodiment, the heavy metals being removed from the municipal wastewater are selected from the group consisting of: Pb; Cu; Zn; Cd; Ni; Hg; Ag; Co; Pd; Sn; Sb; Ba; Be; and a combination thereof.

The ethylene dichloride ammonia polymers are prepared by the reaction of ethylene dichloride and ammonia. The starting ethylene dichloride ammonia polymers generally have a molecular weight range of 500-100,000. In a preferred embodiment the molecular weight is 1,500 to 10,000, with a most preferred molecular weight range being 1,500-5,000. A typical reaction for producing these polymers is described in U.S. Pat. No. 5,346,627, which is herein incorporated by reference. The polymers may also be obtained from Nalco Company, 1601 West Diehl Road, Naperville, Ill.

The ethylene dichloride ammonia polymers may be added in varying quantities.

In one embodiment, the effective amount of water-soluble ethylene dichloride-ammonia polymer added to the municipal wastewater is from 1 ppm to about 10,000 ppm active solids.

In another embodiment, the water-soluble ethylene dichloride ammonia polymer added to the municipal wastewater has a molecular weight of about 2,000 to about 2,000,000 daltons.

In another embodiment, the driving force for passage of the treated municipal wastewater through the submerged membrane is positive or negative pressure.

In another embodiment, the treated municipal wastewater that passes through the submerged microfiltration membrane or ultrafiltration membrane may be further processed through one or more membranes.

In yet a further embodiment, the additional membrane is either a reverse osmosis membrane or a nanofiltration membrane.

The submerged membranes utilized to process municipal wastewater containing heavy metals may have various types of physical and chemical parameters.

With respect to physical parameters, in one embodiment, the ultrafiltration membrane has a pore size in the range of 0.003 to 0.1 μm.

In another embodiment, the microfiltration membrane has a pore size in the range of 0.1 to 10 μm.

In another embodiment, the submerged membrane has a configuration selected from the group consisting of: a hollow fiber configuration; a flat plate configuration; or a combination thereof.

In another embodiment, the membrane has a spiral wound configuration.

In another embodiment, the submerged membrane has a capillary configuration.

With respect to chemical parameters, in one embodiment, the submerged membrane is polymeric.

In another embodiment, the membrane is inorganic.

In yet another embodiment, the membrane is stainless steel.

There are other physical and chemical membrane parameters that may be implemented for the claimed invention.

After the municipal wastewater is treated with the water-soluble ethylene dichloride ammonia polymer, the wastewater may be further treated with one or more water-soluble polymers to further increase the particle size and enhance the membrane flux.

In one embodiment, the water-soluble polymers are selected from the group consisting of: amphoteric polymers; cationic polymers; anionic polymers; zwitterionic polymers; and a combination thereof.

In another embodiment, the water soluble polymers have a molecular weight from 10,000 to about 2,000,000 daltons.

In another embodiment, the amphoteric polymers are selected from the group consisting of: dimethylaminoethyl acrylate methyl chloride quaternary salt (DMAEA.MCQ)/acrylic acid copolymer; diallyldimethylammonium chloride/acrylic acid copolymer; dimethylaminoethyl acrylate methyl chloride salt/N,N-dimethyl-N-methacrylamidopropyl-N-(3-sulfopropyl)-ammonium betaine copolymer; acrylic acid/N,N-dimethyl-N-methacrylamidopropyl-N-(3-sulfopropyl)-ammonium betaine copolymer; and DMAEA.MCQ/Acrylic acid/N,N-dimethyl-N-methacrylamidopropyl-N-(3-sulfopropyl)-ammonium betaine terpolymers.

In another embodiment, the dosage of the amphoteric polymers is from about 1 ppm to about 2000 ppm of active solids.

In another embodiment, the amphoteric polymers have a molecular weight of about 5,000 to about 2,000,000 daltons.

In another embodiment, the amphoteric polymers have a cationic charge equivalent to anionic mole charge equivalent ratio of about 3.0:7.0 to about 9.8:0.2.

In another embodiment, the cationic polymers are selected from the group consisting of: polydiallyldimethylammonium chloride (polyDADMAC); polyethyleneimine; polyepiamine; polyepiamine crosslinked with ammonia or ethylenediamine; condensation polymer of ethylenedichloride and ammonia; condensation polymer of triethanolamine and tall oil fatty acid; poly(dimethylaminoethylmethacrylate sulfuric acid salt); and poly(dimethylaminoethylacrylate methyl chloride quaternary salt).

In another embodiment, the cationic polymers are copolymers of acrylamide (AcAm) and one or more cationic monomers selected from the group consisting of: diallyldimethylammonium chloride; dimethylaminoethylacrylate methyl chloride quaternary salt; dimethylaminoethylmethacrylate methyl chloride quaternary salt; and dimethylaminoethylacrylate benzyl chloride quaternary salt (DMAEA.BCQ)

In another embodiment, the dosage of cationic polymers is from about 0.1 ppm to about 1000 ppm active solids

In another embodiment, the cationic polymers have a cationic charge of at least 2 mole percent.

In another embodiment, the cationic polymers have a cationic charge of 100 mole percent.

In another embodiment, the cationic polymers have a molecular weight of about 2,000 to about 10,000,000 daltons.

In another embodiment, the cationic polymers have a molecular weight of about 20,000 to about 2,000,000 daltons.

In another embodiment, the zwitterionic polymers are composed of about 1 to about 99 mole percent of N,N-dimethyl-N-methacrylamidopropyl-N-(3-sulfopropyl)-ammonium betaine and about 99 to about 1 mole percent of one or more nonionic monomers.

The treated wastewater from step c may optionally be clarified.

Various types of membrane separation processes may be utilized.

In one embodiment, the membrane separation process is selected from the group consisting of: a cross-flow membrane separation process, i.e. with continuous aeration for membrane scouring; semi-dead end flow membrane separation process, i.e. with intermittent aeration for membrane scouring, and a dead-end flow membrane separation process, i.e. no aeration for membrane scouring.

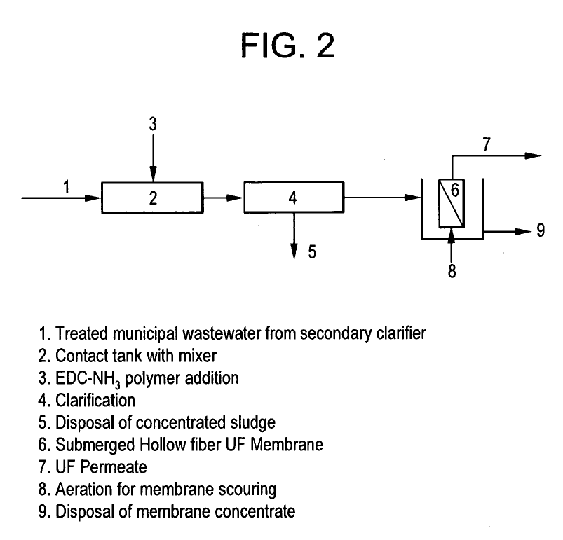

A potential municipal wastewater treatment scheme is shown in FIG. 2.

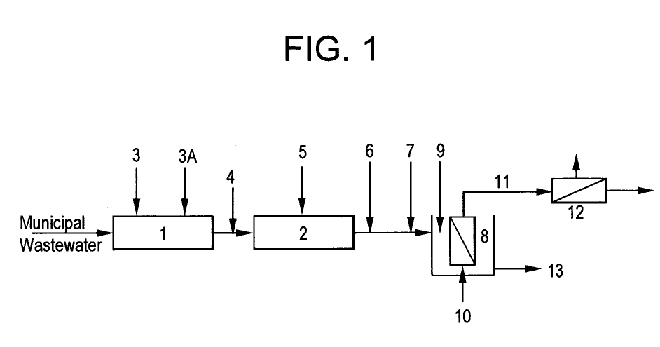

Referring to FIG. 1, municipal wastewater containing heavy metals is collected in a receptacle (1), in which acid or base is added through a line (3) to adjust pH to 3-4. The chelant scavenger such as iron compound is then added through a line (3A). This water then flows in to a receptacle (2), in which the pH is adjusted to 8-10 through in-line (4) or direct (5) addition of base in the receptacle (2). From the receptacle (2) the water then flows to a receptacle (8) in which an ultrafiltration or microfiltration membrane (10) is submerged. Aeration may be applied to the ultrafiltration or microfiltration membrane. The polymeric chelant such as ethylene dichloride-ammonia polymer may be added in-line (6) or directly (9) in to a membrane tank (8). After ethylene dichloride ammonia polymers are added, one or more water-soluble polymers may be added optionally in-line (7) before the water flows into membrane tank (8). The permeate (11) from the submerged ultrafiltration or microfiltration membrane process may be optionally treated by passing the permeate through an additional membrane (12) and the reject (concentrate) (13) may be sent for further dewatering or disposal.

The following example is not intended to limit the scope of the claimed invention.

### EXAMPLE

A secondary treated wastewater was obtained after raw wastewater treatment by a low loaded nitrifying/denitrifying activated sludge process of raw wastewater and subsequent clarification. The secondary treated wastewater obtained from a local municipality contained 17 ppb Zn, 3.1 ppb Cu and 1.99 ppb Ni. This wastewater was treated with 10-20 ppm of ethylene dichloride ammonia (EDC-NH₃) polymer, settled in a clarifier and the clarified water was then filtered through a submerged hollow fiber UF membrane. This process is illustrated by FIG. 2. EDC-NH₃ polymer treatment of the municipal wastewater followed by UF resulted in significant improvement in metal removal than UF alone.

1. A method of removing one or more heavy metals from municipal wastewater by use of a membrane separation process comprising the following steps:
a. collecting a municipal wastewater containing heavy metals in a receptacle suitable to hold said municipal wastewater;
b. adjusting the pH of said system to achieve hydroxide precipitation of said heavy metals in said municipal wastewater;
c. adding an effective amount of a water soluble ethylene dichloride ammonia polymer having a molecular weight of from about 500 to about 10,000 daltons that contain from about 5 to about 50 mole percent of dithiocarbamate salt groups to react with said heavy metals in said municipal wastewater system;
d. optionally clarifying the treated wastewater from step c;
e. passing said treated municipal wastewater through a submerged membrane, wherein said submerged membrane is an ultrafiltration membrane or a microfiltration membrane; and
f. optionally back-flushing said membrane to remove solids from the membrane surface.

2. The method of claim 1, wherein said effective amount of said water soluble ethylene dichloride ammonia polymer is from 1 ppm to about 10,000 ppm.

3. The method of claim 1 further comprising the step of: adjusting the pH of said municipal wastewater systems, after step a and before step b, to de-complex metals from chelants, if present, in said wastewater system and subsequently or simultaneously adding one or more chelant scavengers

4. The method of claim 1, wherein a driving force for passage of said treated municipal wastewater through said submerged membrane is positive or negative pressure.

5. The method of claim 1 further comprising treating the municipal wastewater with one or more water-soluble polymers after step c and before passing through said submerged membrane.

6. The method of claim 1, wherein said ultrafiltration membrane has a pore size in the range of 0.003 to 0.1 μm.

7. The method of claim 1, wherein said microfiltration membrane has a pore size in the range of 0.1 to 10 μm.

8. The method of claim 1, wherein said membrane is selected from the group consisting of stainless steel or polymeric or inorganic.

9. The method of claim 1, wherein the water soluble ethylene dichloride ammonia polymer has a molecular weight of about 2,000 to about 2,000,000 daltons.

10. The method of claim 5, wherein said water-soluble polymers are selected from a group consisting of: amphoteric polymers; cationic polymers; zwitterionic polymers; anionic polymers; and a combination thereof.

11. The method of claim 10, wherein the amphoteric polymers are selected from the group consisting of: dimethylaminoethyl acrylate methyl chloride quaternary salt/acrylic acid copolymer, diallyldimethylammonium chloride/acrylic acid copolymer, dimethylaminoethyl acrylate methyl chloride salt/N,N-dimethyl-N-methacrylamidopropyl-N-(3-sulfopropyl)-ammonium betaine copolymer, acrylic acid/N,N-dimethyl-N-methacrylamidopropyl-N-(3-sulfopropyl)-ammonium betaine copolymer and DMAEA.MCQ/Acrylic acid/N,N-dimethyl-N-methacrylamidopropyl-N-(3-sulfopropyl)-ammonium betaine terpolymer.

12. The method of claim 10, wherein the dosage of the amphoteric polymers are from about 1 ppm to about 2000 ppm of active solids.

13. The method of claim 10, wherein the amphoteric polymers have a molecular weight of about 5,000 to about 2,000,000 daltons.

14. The method of claim 10, wherein the amphoteric polymers have a cationic mole charge equivalent to an anionic mole charge equivalent ratio of about 3.0:7.0 to about 9.8:0.2.

15. The method of claim 10, wherein the cationic polymers are selected from the group consisting of: polydiallyldimethylammonium chloride; polyethyleneimine; polyepiamine; polyepiamine crosslinked with ammonia or ethylenediamine; condensation polymer of ethylenedichloride and ammonia; condensation polymer of triethanolamine an tall oil fatty acid; poly(dimethylaminoethylmethacrylate sulfuric acid salt); and poly(dimethylaminoethylacrylate methyl chloride quaternary salt).

16. The method of claim 10, wherein the cationic polymers are copolymers of acrylamide and one or more cationic monomers selected from the group consisting of: diallyldimethylammonium chloride; dimethylaminoethylacrylate methyl chloride quaternary salt; dimethylaminoethylmethacrylate methyl chloride quaternary salt; and dimethylaminoethylacrylate benzyl chloride quaternary salt.

17. The method of claim 10, wherein the dosage of cationic polymers is from about 0.1 ppm to about 1000 ppm active solids.

18. The method of claim 10, wherein the cationic polymers have a cationic charge of at least about 2 mole percent.

19. The method of claim 10, wherein the cationic polymers have a cationic charge of 100 mole percent.

20. The method of claim 10, wherein the cationic polymers have a molecular weight of about 2,000 to about 10,000,000 daltons.

21. The method of claim 10, wherein the cationic polymers have a molecular weight of about 20,000 to 2,000,000 daltons.

22. The method of claim 10, wherein the zwitterionic polymers are composed of about 1 to about 99 mole percent of N,N-dimethyl-N-methacrylamidopropyl-N-(3-sulfopropyl)-ammonium betaine and about 99 to about 1 mole percent of one or more nonionic monomers.

23. The method of claim 1, wherein the submerged membrane separation process is selected from the group consisting of: a cross-flow membrane separation process; semi-dead end flow membrane separation process; and a dead-end flow membrane separation process.

24. The method of claim 1 further comprising: passing a filtrate from said membrane through an additional membrane.

25. The method of claim 24, wherein said additional membrane is a reverse osmosis membrane.

26. The method of claim 24, wherein said additional membrane is a nanofiltration membrane.

27. The method of claim 1, wherein said submerged membrane has a configuration selected from the group consisting of: a hollow fiber configuration; a flat plate configuration; or a combination thereof.

28. The method of claim 5, wherein said water soluble polymers have a molecular weight from 10,000 to about 2,000,000 daltons.

29. The method of claim 10, wherein cationic polymers have a cationic charge between 20 mole percent and 50 mole percent.

30. The method of claim 1, wherein the heavy metals in said municipal wastewater are selected from the group consisting of: Pb; Cu; Zn; Cd; Ni; Hg; Ag; Co; Pd; Sn; Sb; Ba; Be; or a combination thereof.

31. The method of claim 3 wherein said pH adjustment after step a and before step b is to less than 4.

32. The method of claim 3 wherein said chelant scavengers contain Ca or Mg or Al or Fe.

33. The method of claim 32 wherein said chelant scavenger containing Fe is selected from the group consisting of: ferrous chloride; ferrous sulfate; ferric chloride; ferric sulfate; or a combination thereof.
